(19) United States
(12) Patent Application Publication
(10) Pub. No.: US 2014/0001928 A1
(43) Pub. Date: Jan. 2, 2014

(54) SPINDLE MOTOR

(71) Applicant: Nam Ki PARK, Suwon (KR)

(72) Inventor: Nam Ki PARK, Suwon (KR)

(73) Assignee: SAMSUNG ELECTRO-MECHANICS CO., LTD., Suwon (KR)

(21) Appl. No.: 13/605,671

(22) Filed: Sep. 6, 2012

(30) Foreign Application Priority Data
Jun. 27, 2012 (KR) 10-2012-0069396

(51) Int. Cl. H02K 7/116

(52) U.S. Cl. 310/75 R

(57) ABSTRACT

There is provided a spindle motor including: a base member; a holding member having a lower end portion fixedly connected to the base member and a stator core installed on an outer peripheral surface thereof; a sleeve fixedly installed on an inner peripheral surface of the holding member; a shaft rotatably supported by the sleeve; and a rotor hub installed on an upper end portion of the shaft to rotate together therewith.

### CROSS-REFERENCE TO RELATED APPLICATIONS

This application claims the priority of Korean Patent Application No. 10-2012-0069396 filed on Jun. 27, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device in a computer, reads data stored on a disk or writes data to a disk using a magnetic head.

In a hard disk drive, a base plate may be provided with a head driver capable of moving the magnetic head across the surface of the disk. The magnetic head performs its function while moving to a desired position in a state in which it is separated from a writing surface of the disk by a predetermined height by the head driver.

According to the related art, in manufacturing a base plate provided in the hard disk drive, a post-processing scheme of die-casting aluminum (Al) and then removing burrs, or the like, generated due to the die-casting therefrom, has been used.

However, in the die-casting scheme according to the related art, since a process of injecting molten aluminum (Al) for casting to make a form is performed, high temperatures and large amounts of pressure are required, such that a large amount of energy is required to be expended in the process and a process time may be increased.

Further, even in terms of a lifespan of a die-casting mold, there is a limitation in casting a large number of base plates using a single mold, and a base plate manufactured by the die-casting process has poor dimensional precision.

Therefore, in order to solve problems inherent in the die-casting process, a base member has been manufactured by a pressing or forging process. However, in the case of manufacturing a base member using a pressing or forging process, a stator core installation member for installing a stator core should be separately installed on the base member.

That is, since the stator core may not be directly installed on the base member manufactured by the pressing or forging process and having a uniform thickness, the stator core installation member should be installed on the base member.

Further, since the stator core installation member is generally manufactured in a die-casting or injection molding process, a phenomenon in which the center of the stator core is eccentric with regard to a central axis of a shaft may be generated due to assembly tolerance between the stator core installation member and the base member and processing tolerance thereof.

That is, since the stator core installation member is manufactured in a die-casting or injection molding process, assembly tolerance is increased at the time of assembling the stator core installation member, the base member, and a sleeve. Therefore, a phenomenon in which the center of the stator core is eccentric with regard to the central axis of the shaft may be generated.

### RELATED ART DOCUMENT

(Patent Document 1) Korean Patent Laid-Open Publication No. 2000-20562

### SUMMARY OF THE INVENTION

An aspect of the present invention provides a spindle motor capable of reducing a phenomenon in which a center of a stator core is eccentric with regard to a central axis of a shaft.

According to an aspect of the present invention, there is provided a spindle motor including: a base member; a holding member having a lower end portion fixedly connected to the base member and a stator core installed on an outer peripheral surface thereof; a sleeve fixedly installed on an inner peripheral surface of the holding member; a shaft rotatably supported by the sleeve; and a rotor hub installed on an upper end portion of the shaft to rotate together therewith.

The rotor hub may include an extension wall part extended so as to be disposed outwardly of the sleeve in a radial direction, and the holding member may include a protrusion part disposed to face the extension wall part and form a labyrinth seal together therewith.

The sleeve may have a protrusion formed on an outer peripheral surface thereof so as to guide the holding member to a mounting location thereof.

The base member may be manufactured by shaping a steel plate by plastic working.

The base member may include a seating part corresponding to the lower end portion of the holding member, and the seating part may have a shape corresponding to that of the lower end portion of the holding member so that the holding member is seated thereon.

The spindle motor may further include a cover member mounted on a lower end of the sleeve to prevent leakage of a lubricating fluid.

At least one of an outer peripheral surface of the shaft and an inner peripheral surface of the sleeve may be provided with upper and lower radial dynamic pressure grooves generating fluid dynamic pressure at the time of rotation of the shaft.

The holding member may be fixedly installed through at least one of a press-fitting scheme, a welding scheme, and an adhering scheme.

Another aspect of the present invention provides a spindle motor including: a base member shaped by plastic working; a holding member having a lower end portion fixedly connected to the base member and a stator core installed on an outer peripheral surface thereof; a sleeve fixedly installed on an inner peripheral surface of the holding member; a cover member mounted on a lower end of the sleeve to prevent leakage of a lubricating fluid; a shaft rotatably supported by the sleeve; a rotor hub installed on an upper end portion of the shaft to rotate together therewith; and a separation prevention member disposed on the stator core to thereby prevent the stator core from being separated from the holding member.

The holding member may include a protrusion part extended upwardly in an axial direction, and the separation prevention member may be disposed at an upper end portion of an outer peripheral surface of the protrusion part.

The rotor hub may include an extension wall part extended so as to be disposed outwardly of the sleeve in a radial direction, the holding member may include a protrusion part disposed to face the extension wall part and form a labyrinth seal together therewith, and the sleeve may have a protrusion formed on an outer peripheral surface thereof so as to guide the holding member to a mounting location thereof.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a partially cut-away perspective view showing the spindle motor according to the embodiment of the present invention;

FIG. 4 is a schematic cross-sectional view showing a spindle motor according to another embodiment of the present invention; and

FIG. 5 is a partially cut-away perspective view showing a holding member, a stator core, and a separation prevention member included in the spindle motor according to another embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

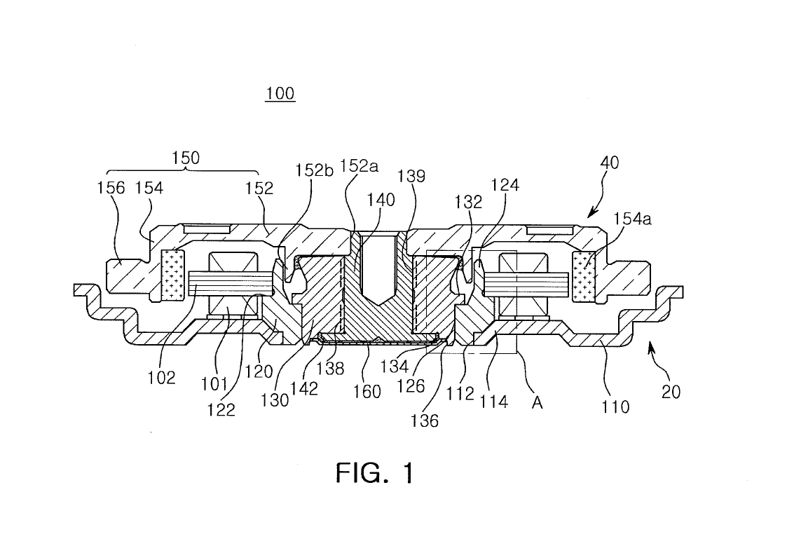

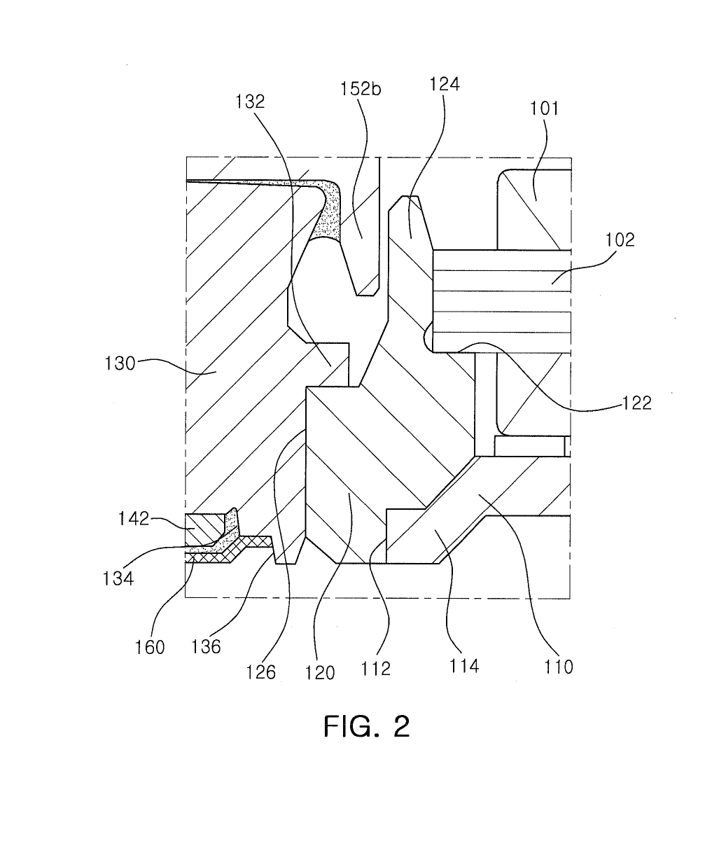

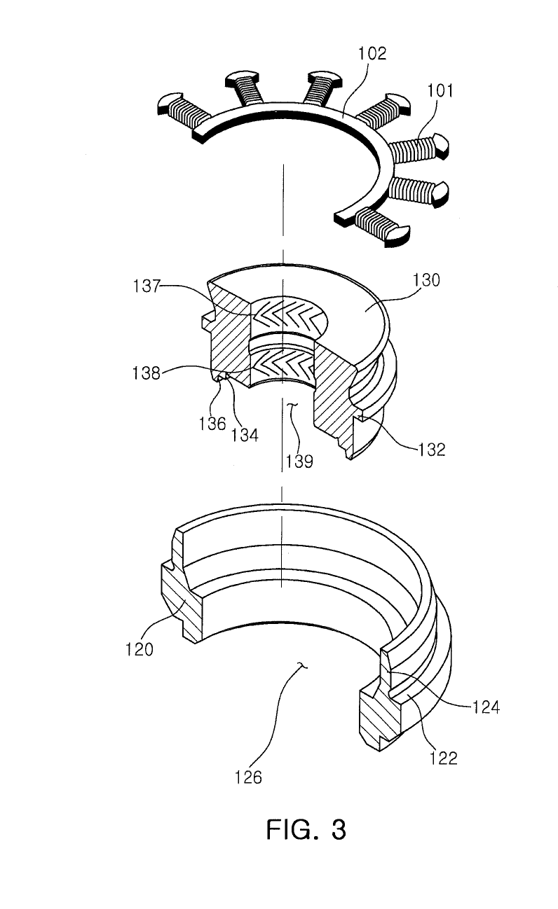

FIG. 1 is a schematic cross-sectional view showing a spindle motor according to an embodiment of the present invention; FIG. 2 is an enlarged view of part A of FIG. 1; and FIG. 3 is a partially cut-away perspective view showing the spindle motor according to the embodiment of the present invention.

Referring to FIGS. 1 through 3, a spindle motor 100 according to an embodiment of the present invention may include, for example, a base member 110, a holding member 120, a sleeve 130, a shaft 140, a rotor hub 150, and a cover member 160.

Meanwhile, the spindle motor 100 according to the embodiment of the present invention may be a motor used in an information recording and reproducing device such as a disk driving device, or the like.

In addition, the spindle motor 100 according to the embodiment of the present invention may be mainly configured of a stator 20 and a rotor 40.

The stator 20, which refers to all fixed members with the exception of rotating members, may include the base member 110, the holding member 120, the sleeve 130, the cover member 160, and the like.

The rotor 40, which refers to rotating members, may include the shaft 140, the rotor hub 150, and the like.

Here, terms with respect to directions will be defined. As viewed in FIG. 1, an axial direction refers to a vertical direction based on the shaft 140, while a radial direction refers to a direction from the shaft 140 toward an outer peripheral surface of the rotor hub 150 or from the outer peripheral surface of the rotor hub 150 toward the shaft 140.

In addition, a circumferential direction refers to a rotation direction along an outer peripheral surface of the shaft 140 or the outer peripheral surface of the rotor hub 150.

The base member 110, a fixed member configuring the stator 20, may be shaped by plastic working. As an example, the base member 110 may be molded by press working. In addition, the base member 110 may be shaped by performing the plastic working on a steel plate having a predetermined thickness, that is, a cold rolled steel sheet (SPCC, SPCE, or the like) or a hot rolled steel sheet.

Here, an overall shape of the base member 110 may also be shaped through a post-process such as a bending process, a cutting process, and the like, after the plastic working.

The base member 110 manufactured as described above may have a predetermined thickness.

Meanwhile, the base member 110 may be provided with an installation hole 112. Lower end portions of the holding member 120 and the sleeve 130 may be insertedly disposed in the installation hole 112.

In addition, the base member 110 may be provided with a seating part 114 so that the holding member 120 may be seated and installed thereon. The seating part 114 may be disposed to be adjacent to the installation hole 112 and have a shape corresponding to that of the lower end portion of the holding member 120.

The holding member 120 may be a fixed member configuring the stator 20 together with the base member 110. In addition, the holding member 120 may be fixedly connected to a lower end portion of the base member 110 and have a stator core 102 installed on an outer peripheral surface thereof.

That is, the holding member 120 may have a support surface 122 formed on the outer peripheral surface thereof so that the stator core 102 may be seated thereon, and the stator core 102 may be coupled to the holding member 120 by an adhesive and/or welding in the state in which it is seated on the support surface 122 of the holding member 120.

Meanwhile, the holding member 120 may be provided with a protrusion part 124 extended upwardly in the axial direction. A detailed description of the protrusion part 124 will be provided below.

In addition, the holding member 120 may be fixedly connected to the base member 110 in at least one of a press-fitting scheme, a welding scheme, and an adhering scheme. That is, the holding member 120 may be fixedly connected to the seating part 114 of the base member 110 by the adhesive or welding. Further, the holding member 120 may be press-fitted into the installation hole 112 of the base member 110.

In addition, the holding member 120 may be fixedly connected to the seating part 114 of the base member 110 in two schemes, that is, a press-fitting scheme and a welding scheme.

Meanwhile, the holding member 120 may have an insertion hole 126 formed therein so that the sleeve 130 may be inserted thereinto. That is, the holding member 120 may have a shape that it has the insertion hole 126 formed at a central portion thereof in the axial direction.

The sleeve 130, a fixed member configuring the stator 20 together with the base member 110 and the holding member 120, may be fixedly installed on an inner peripheral surface of the holding member 120. That is, the sleeve 130 may be insertedly disposed in the insertion hole 126, such that an outer surface of the sleeve 130 may be bonded to the inner peripheral surface of the holding member 120.

Meanwhile, the sleeve 130 may also be fixedly connected to the holding member in at least one of a press-fitting scheme, a welding scheme, and an adhering scheme.

As described above, since the holding member 120 having the stator core 102 installed thereon is directly coupled to the sleeve 130, an eccentricity phenomenon between the center of the stator core 102 and the central axis of the shaft 140 due to assembly tolerance and processing tolerance may decrease.

That is, since the holding member 120 is directly coupled to the sleeve 130, the phenomenon in which the center of the stator core 102 is eccentric with regard to the central axis of the shaft 140 may decrease, as compared to the case in which a member having the stator core 102 installed thereon is fixedly connected to the base member 110 and the sleeve 130 is fixedly connected to the base member 130.

In addition, the sleeve 130 may include a protrusion 132 formed on an outer peripheral surface thereof so as to guide the holding member 120 to a mounting location thereof at the time of coupling between the sleeve 130 and the holding member 120. That is, at the time of the coupling between the holding member 120 and the sleeve 130, the sleeve 130 may be inserted into the insertion hole 126 of the holding member 120 until the holding member 120 contacts the protrusion 132.

That is, since the holding member 120 is coupled to the sleeve 130 based on a lower surface of the protrusion 132, the holding member 120 and the sleeve 130 may be always coupled at a predetermined location. Therefore, the protrusion 132 may serve as an assembly reference.

Meanwhile, a lower end portion of the sleeve 130 may be provided with an insertion groove 134 into which a flange part 142 of the shaft 140 to be described below is inserted and an installation groove 136 in which the cover member 160 is installed.

The installation groove 136 may be depressed from a lower surface of the sleeve 130, and the insertion groove 134 may be stepped with respect to the installation groove 136 and be depressed from the installation groove 136.

In addition, the sleeve 120 may include upper and lower radial dynamic pressure grooves 137 and 138 formed in an inner peripheral surface thereof in order to generate fluid dynamic pressure at the time of rotation of the shaft 140.

The upper and lower radial dynamic pressure grooves 137 and 138 may have a herringbone shape. However, the upper and lower radial dynamic pressure grooves 137 and 138 are not limited to having the above-mentioned shape, but may also have a spiral shape.

Further, an upper end portion of the outer peripheral surface of the sleeve 130 may be inclined so that it may form an interface between a lubricating fluid and air together with the rotor hub 150.

In addition, the sleeve 130 may include a shaft hole 139 formed therein so as to rotatably support the shaft 140, wherein the shaft hole 139 has the shaft 140 insertedly disposed therein.

The shaft 140, a rotating member configuring the rotor 40, may be rotatably supported by the sleeve 130. In addition, as described above, in the case in which the shaft 140 is inserted into the sleeve 130, the outer peripheral surface of the shaft 140 and the inner peripheral surface of the sleeve 130 may be disposed to be spaced apart from each other by a predetermined interval to form a bearing clearance.

The bearing clearance is filled with the lubricating fluid. The lubricating fluid is pumped by the upper and lower radial dynamic pressure grooves 137 and 138 as described above at the time of the rotation of the shaft 140, such that fluid dynamic pressure may be generated.

The shaft 140 may rotate more stably by the fluid dynamic pressure generated as described above.

Meanwhile, the shaft 140 may include the flange part 142 provided at a lower portion thereof in order to prevent the shaft 120 from being separated from the sleeve 120 due to an external impact. The flange part 142 may also serve to prevent the shaft 140 from being excessively floated at the time of the rotation of the shaft 140.

Meanwhile, the flange part 142 may be disposed in the insertion groove 134 of the sleeve 130.

The rotor hub 150 may be installed on the upper end portion of the shaft 140 to rotate together with the shaft 140. That is, the rotor hub 150 may be a rotating member configuring the rotor 40 together with the shaft 140.

Meanwhile, the rotor hub 150 may include a body 152 provided with a shaft insertion hole 152a inserted into the upper end portion of the shaft 140, a magnet mounting part 154 extended from an edge of the body 162 downwardly in the axial direction, and a disk seating part 156 extended from the magnet mounting part 154 in the radial direction.

In addition, the magnet mounting part 154 may include a driving magnet 154a fixedly connected to an inner surface thereof. Therefore, an inner surface of the driving magnet 154a may be disposed to face a front end of the stator core 102.

Meanwhile, the driving magnet 154a may be a permanent magnet generating magnetic force having a predetermined strength by alternately magnetizing an N pole and an S pole thereof in the circumferential direction.

Hereinafter, rotational driving scheme of the rotor hub 150 will be described. When power is supplied to a coil 101 wound around the stator core 102, driving force for rotating the rotor hub 150 may be generated by electromagnetic interaction between the stator core 102 having the coil 101 wound therearound and the driving magnet 154a.

That is, the rotor hub 150 may rotate by the electromagnetic interaction between the driving magnet 154a disposed to face the front end of the stator core 102 and the stator core 102 having the coil 101 wound therearound.

Therefore, the shaft 140 coupled to the rotor hub 150 may rotate together with the rotor hub 150.

Meanwhile, the rotor hub 150 may include an extension wall part 152b extended so as to be disposed outwardly of the sleeve 130 in the radial direction. That is, the rotor hub 150 may include the extension wall part 152b extended from the body 152 downwardly in the axial direction.

An inner peripheral surface of the extension wall part 152b may serve to form an interface between the lubricating fluid filling the bearing clearance and the air together with the upper end portion of the outer peripheral surface of the sleeve 130. In addition, an outer peripheral surface of the extension wall part 152b and an inner surface of the protrusion part 124 may be disposed to be spaced apart from each other by a predetermined interval to form a labyrinth seal.

Therefore, evaporation of the lubricating fluid may be suppressed. That is, a clearance formed by the outer peripheral surface of the extension wall part 152b and the inner surface of the protrusion part 124 of the holding member 120 is narrow to thereby suppress a flow of the air, such that the evaporation of the lubricating fluid may be suppressed.

The cover member 160, a fixed member configuring the stator 20 together with the sleeve 130, may be installed in the lower end portion of the sleeve 130 to serve to prevent leakage of the lubricating fluid.

That is, the cover member 160 may be fixedly connected to the installation groove 136 of the sleeve 130 and be installed through any one of a welding scheme and an adhering scheme.

As described above, since the holding member 120 having the stator core 102 installed on the outer peripheral surface thereof is directly assembled to the sleeve 130, the assembly tolerance and the processing tolerance may decrease.

That is, the phenomenon in which the center of the stator core 102 is eccentric with regard to the central axis of the shaft 140 may further decrease, as compared to the case in which the holding member 120 having the stator core 102 installed thereon is installed on the base member 110 and the sleeve 130 is installed on the base member 110.

Further, since the protrusion part 124 of the holding member 120 and the extension wall part 152b of the rotor hub 150 form the labyrinth seal, the evaporation of the lubricating fluid may be suppressed.

As a result, rotation characteristics of the rotor 40 may be improved by the holding member 120.

Hereinafter, a spindle motor according to another embodiment of the present invention will be described with reference to the accompanying drawings. However, the same components as the above-mentioned components will be denoted by the same reference numerals and a detailed description thereof will be omitted.

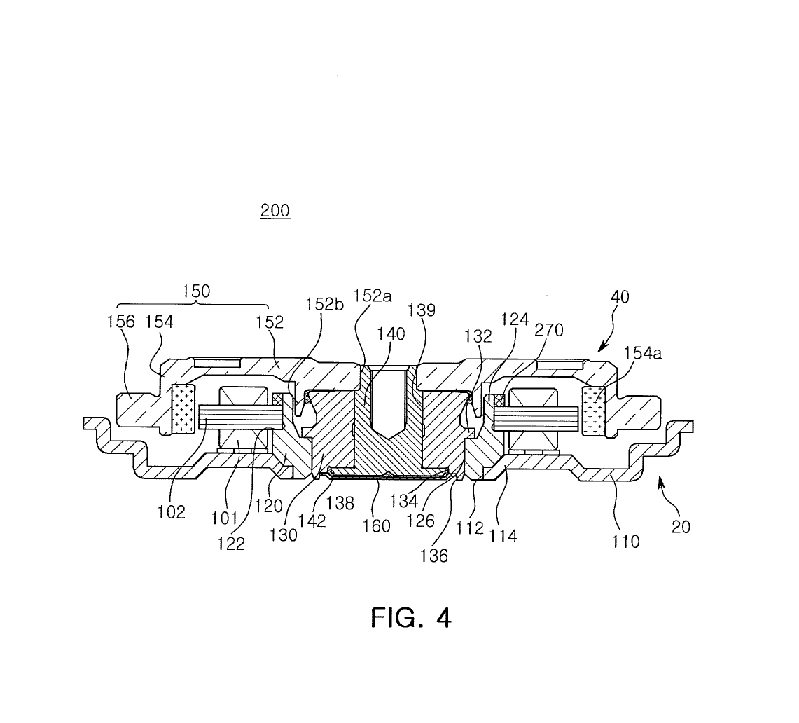

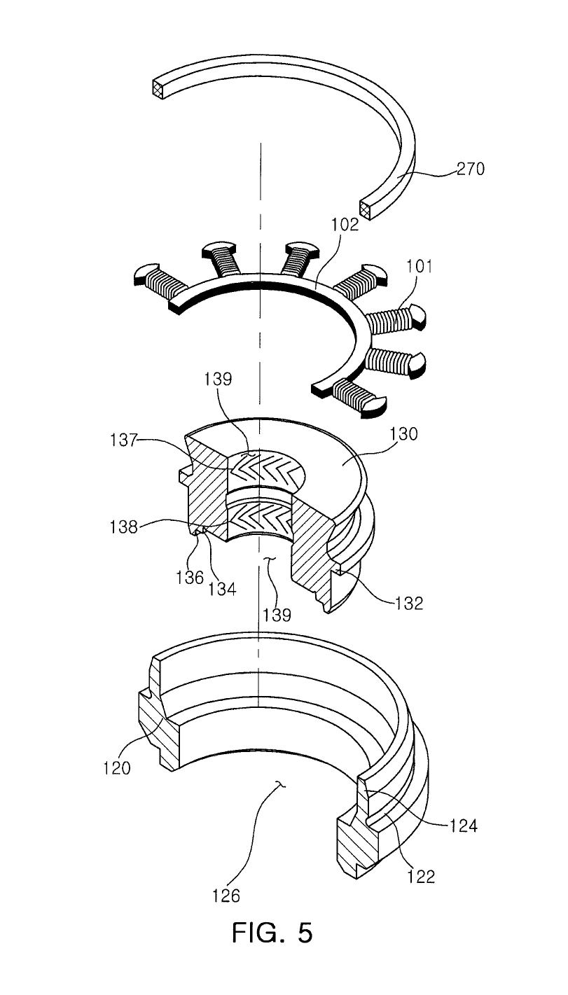

FIG. 4 is a schematic cross-sectional view showing a spindle motor according to another embodiment of the present invention, and FIG. 5 is a partially cut-away perspective view showing a holding member, a stator core, and a separation prevention member included in the spindle motor according to another embodiment of the present invention.

Referring to FIGS. 4 and 5, a spindle motor 200 according to another embodiment of the present invention may further include a separation prevention member 270, in addition to all the components included in the spindle motor 100 according to the above-described embodiment of the present invention.

Therefore, a detailed description of the base member 110, the holding member 120, the sleeve 130, the shaft 140, the rotor hub 150, and the cover member 160 will be omitted.

Hereinafter, only the separation prevention member 270 will be described.

The separation prevention member 270 may be disposed on the stator core 102 to serve to prevent the stator core 102 from being separated from the holding member 120.

That is, the separation prevention member 270 may be fixedly connected to an upper end portion of an outer peripheral surface of the protrusion part 124 of the holding member 120 to prevent the separation of the holding member 120.

In addition, the separation prevention member 270 may be made of a material having elasticity such as a rubber, a synthetic resin, or the like, and be installed on the holding member 120 in order to press an upper surface of the stator core 102.

Therefore, in the case in which vibrations are generated from the stator core 102, the separation prevention member 270 may serve to absorb the vibrations to decrease the vibrations generated from the stator core 102.

Further, although the present embodiment describes a case in which the separation prevention member 270 is manufactured as a member separated from the holding member 120 and is then installed on the holding member 120 by way of example, the present invention is not limited thereto. As an example, the separation prevention member 270 may be formed integrally with the protrusion part 124 of the holding member 120 and be bent after the installation of the stator core 102 to contact the upper surface of the stator core 102.

As described above, the separation of the stator core 102 from the holding member 120 at the time of an external impact may be prevented through the separation prevention member 270 installed on the protrusion part 124 so as to contact the upper surface of the stator core 102.

In addition, the vibrations generated from the stator core 102 may be alleviated through the separation prevention member 270 made of a material having elasticity.

As set forth above, according to the embodiments of the present invention, the sleeve is installed on the inner peripheral surface of the holding member and the stator core is installed on the outer peripheral surface of the holding member, whereby assembly tolerance and processing tolerance may decrease.

Therefore, the phenomenon in which the center of the stator core is eccentric with regard to the central axis of the shaft may decrease.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member;
a holding member having a lower end portion fixedly connected to the base member and a stator core installed on an outer peripheral surface thereof;
a sleeve fixedly installed on an inner peripheral surface of the holding member;
a shaft rotatably supported by the sleeve; and
a rotor hub installed on an upper end portion of the shaft to rotate together therewith.

2. The spindle motor of claim 1, wherein the rotor hub includes an extension wall part extended so as to be disposed outwardly of the sleeve in a radial direction, and
the holding member includes a protrusion part disposed to face the extension wall part and form a labyrinth seal together therewith.

3. The spindle motor of claim 1, wherein the sleeve has a protrusion formed on an outer peripheral surface thereof so as to guide the holding member to amounting location thereof.

4. The spindle motor of claim 1, wherein the base member is manufactured by shaping a steel plate by plastic working.

5. The spindle motor of claim 1, wherein the base member includes a seating part corresponding to the lower end portion of the holding member, and
the seating part has a shape corresponding to that of the lower end portion of the holding member so that the holding member is seated thereon.

6. The spindle motor of claim 1, further comprising a cover member mounted on a lower end of the sleeve to prevent leakage of a lubricating fluid.

7. The spindle motor of claim 6, wherein at least one of an outer peripheral surface of the shaft and an inner peripheral surface of the sleeve is provided with upper and lower radial dynamic pressure grooves generating fluid dynamic pressure at the time of rotation of the shaft.

8. The spindle motor of claim 1, wherein the holding member is fixedly installed through at least one of a press-fitting scheme, a welding scheme, and an adhering scheme.

9. A spindle motor comprising:
a base member shaped by plastic working;
a holding member having a lower end portion fixedly connected to the base member and a stator core installed on an outer peripheral surface thereof;
a sleeve fixedly installed on an inner peripheral surface of the holding member;
a cover member mounted on a lower end of the sleeve to prevent leakage of a lubricating fluid;
a shaft rotatably supported by the sleeve;
a rotor hub installed on an upper end portion of the shaft to rotate together therewith; and
a separation prevention member disposed on the stator core to thereby prevent the stator core from being separated from the holding member.

10. The spindle motor of claim 9, wherein the holding member includes a protrusion part extended upwardly in an axial direction, and
the separation prevention member is disposed at an upper end portion of an outer peripheral surface of the protrusion part.

11. The spindle motor of claim 9, wherein the rotor hub includes an extension wall part extended so as to be disposed outwardly of the sleeve in a radial direction,
the holding member includes a protrusion part disposed to face the extension wall part and form a labyrinth seal together therewith, and
the sleeve has a protrusion formed on an outer peripheral surface thereof so as to guide the holding member to a mounting location thereof.
